(19) United States
(12) Patent Application Publication
(10) Pub. No.: US 2008/0006461 A1
(43) Pub. Date: Jan. 10, 2008

(54) Vehicle

(76) Inventor: Yoshiaki Naganuma, Aichi-ken (JP)

Correspondence Address: KENYON & KENYON LLP, 1500 K STREET N.W., SUITE 700, WASHINGTON, DC, 20005, US

(21) Appl. No.: 11/794,090

(22) PCT Filed: Jan. 6, 2006
(86) PCT No.: PCT/JP06/00106

§ 371 Date: Jun. 25, 2007

(30) Foreign Application Priority Data
Jan. 7, 2005 (JP) 2055-002271
Jan. 7, 2005 (JP) 2005-002271

(51) Int. Cl. B60K 15/067; B60H 1/00; B62D 31/02; B60K 11/04

(52) U.S. Cl. 180/69.4; 180/68.4

(57) ABSTRACT

A hydrogen tank is placed substantially at a middle portion in a fore/aft direction on a roof of a fuel cell-equipped bus, an air conditioning unit is placed on the front of the hydrogen tank and a radiator is placed on the rear thereof, and these components are covered with a roof cover. An outside air guiding portion that guides outside air to an outside air introducing opening of the air conditioning unit is provided in the middle of an upward inclined surface in a front portion of the roof cover and above a front portion of the air conditioning unit, and a partition wall portion that separates the hydrogen tank from the air conditioning unit is provided in the periphery of the air conditioning unit on the side of the hydrogen tank. Thus, hydrogen leaking from the hydrogen tank flows rearward by running air, and can be prevented from entering an occupant compartment through the outside air introducing opening of the air conditioning unit.

### TECHNICAL FIELD

The present invention relates to a vehicle, and more particularly to a vehicle that runs using power from a power source.

### BACKGROUND ART

A conventionally known vehicle of this type includes an engine using gas fuel such as CNG (compression natural gas). For using such a vehicle as, for example, a route bus, it is proposed to place a gas fuel cylinder on a roof in order to provide a low floor in terms of barrier-free access for the elderly (for example, see Japanese Patent Laid-Open No. 2001-239846).

As a method for cooling a power source of a vehicle of this type, a fuel cell device is proposed in which a fuel cell as a power source and a radiator are connected by a cooling tube, and the radiator is placed to be exposed to outside air (for example, see Japanese Patent Laid-Open No. 2001-93556). When this device is mounted to, for example, an automobile, the radiator is placed below a wing of an air spoiler, and air collected by the air spoiler is applied to the radiator to increase cooling efficiency.

### DISCLOSURE OF THE INVENTION

In the above described vehicle, an air conditioning unit for conditioning air in an occupant compartment is sometimes placed on a roof in order to provide a low floor. In this case, if a gas fuel cylinder is placed on the roof, gas fuel leaking from the gas fuel cylinder may enter the occupant compartment through an outside air introducing opening of the air conditioning unit.

In the case of mounting such a fuel cell device to a vehicle such as a bus, it is sometimes preferable to place a gas tank that stores hydrogen gas or the like on a roof in order to provide a low floor for easy loading and unloading. In this case, the gas tank occupies most of a space on the roof, which may make it difficult to place a radiator in a position where sufficient running air can be introduced, or prevent a space required for maintenance of the gas tank from being ensured.

A vehicle according to the present invention has an object to prevent gas fuel leaking from a gas fuel tank from entering an occupant compartment. The vehicle according to the present invention has one object to more properly place an air conditioning unit and the gas fuel tank on a roof. Further, the vehicle according to the present invention has one object to increase cooling efficiency of a radiator for a power source while ensuring a space for placement of the gas fuel tank. Alternatively, the vehicle according to the present invention has one object to more properly place the gas fuel tank and the radiator for a power source on the roof.

In order to achieve at least part of the above described objects, the vehicle according to the present invention adopts means described below.

The present invention is directed to a first vehicle that runs using power from a power source. The first vehicle includes: a gas fuel tank that stores gas fuel to be supplied to the power source, and is placed on a vehicle body roof; an air conditioning unit that is placed on the front in a vehicle fore/aft direction of the gas fuel tank on the vehicle body roof, has an outside air introducing opening that introduces outside air, and conditions air in an occupant compartment using the outside air introduced from the outside air introducing opening.

In the first vehicle of the present invention, the gas fuel tank is placed on the vehicle body roof, and the air conditioning unit is placed on the front of the gas fuel tank. Thus, gas fuel leaking from the gas fuel tank flows rearward by running air, and as compared with the case where the air conditioning unit is placed on the rear of the gas fuel tank, the gas fuel can be more properly prevented from entering an occupant compartment through the outside air introducing opening of the air conditioning unit. The gas fuel tank may be horizontally placed on the vehicle body roof so that a longitudinal direction thereof is in a vehicle width direction, may be horizontally placed on the vehicle body roof so that the longitudinal direction thereof is in the vehicle fore/aft direction, or may be vertically placed on the vehicle body roof so that the longitudinal direction thereof is in the vehicle width direction or the vehicle fore/aft direction.

In the first vehicle of the present invention, the gas fuel tank may be placed substantially at a middle portion in the vehicle fore/aft direction on the vehicle body roof. Thus, the gas fuel tank having a relatively heavy weight is placed substantially at the middle portion in the vehicle fore/aft direction, thereby ensuring a good weight balance. This can increase vehicle mobility such as pivotability. In this case, the gas fuel tank may be horizontally placed on the vehicle body roof so that the longitudinal direction thereof is in the vehicle width direction, may be horizontally placed on the vehicle body roof so that the longitudinal direction thereof is in the vehicle fore/aft direction, or may be vertically placed on the vehicle body .roof so that the longitudinal direction thereof is in the vehicle width direction or the vehicle fore/aft direction. The gas fuel tank may have a substantially cylindrical shape.

The first vehicle of the present invention may further include a roof cover that covers at least the gas fuel tank and the air conditioning unit, and has an outside air guiding opening that guides outside air to the outside air introducing opening of the air conditioning unit. In this case, the air conditioning unit may be formed to be lower than the gas fuel tank, and the roof cover may be formed so that a portion above the air conditioning unit is lower than a portion above the gas fuel tank. Thus, a front portion of the roof cover may be formed into a shape rising from the portion above the air conditioning unit to the portion above the gas fuel tank. This can reduce aerodynamic resistance of the vehicle.

In the first vehicle of the present invention of the aspect including the roof cover, the roof cover may have a partition portion that separates the outside air introducing opening of the air conditioning unit from the gas fuel tank. This can more reliably prevent gas fuel leaking from the gas fuel tank from entering the occupant compartment. In the vehicle of the present invention of this aspect, the roof cover may have a ventilating hole in an upper portion from a middle portion to a rear portion in the vehicle fore/aft direction. This can separate the ventilating hole from the air conditioning unit, and thus prevent gas fuel discharged outside from the inside of the roof cover through the ventilating hole from entering the occupant compartment through the outside air introducing opening of the air conditioning unit.

The first vehicle of the present invention may further include a radiator that is placed on the rear in the vehicle fore/aft direction of the gas fuel tank on the vehicle body roof, and used for a cooling system of the power source. Thus, gas fuel leaking from the gas fuel tank is easily mixed with running air introduced to the radiator on the rear, thereby more properly preventing the gas fuel from entering the occupant compartment.

The first vehicle of the present invention of the aspect including the radiator may include a roof cover that covers the vehicle body roof, and has an upper outside air introducing opening that opens so as to introduce to the radiator outside air passing through an upper side with running of the vehicle. Thus, the radiator can be cooled using outside air passing through the upper side of the gas fuel tank. This can increase cooling efficiency of the radiator for a power source while ensuring a space for placement of the gas fuel tank. Also, the upper outside air introducing opening is provided on the rear of the gas fuel tank, and thus gas fuel leaking from the gas fuel tank can be diluted using the outside air introduced into the upper outside air introducing opening. The upper outside air introducing opening that introduces the outside air passing through the upper side to the radiator, which is because if a side outside air introducing opening is provided that introduces outside air passing through a lateral side to a radiator, the outside air needs to be introduced from as far forward as possible (the side closer to the gas fuel tank) for sufficiently introducing the outside air passing through the lateral side, which reduces spaces near opposite ends in a vehicle width direction of a gas fuel tank, while the outside air passing through the upper side is introduced to allow sufficient outside air to be introduced and ensure a maintenance space for the gas fuel tank.

In the first vehicle of the present invention of the aspect including the radiator and the roof cover, the roof cover may have a downward inclined surface descending from the portion above the gas fuel tank placed at the rearmost portion in the vehicle fore/aft direction to a lower end of the upper outside air introducing opening. This allows the outside air to be guided into the upper outside air introducing opening effectively using the shape of the substantially cylindrical gas fuel tank. Further in this case, the roof cover may have wall portions on opposite sides of the downward inclined surface in the vehicle width direction. This allows the outside air to be guided into the upper outside air introducing opening more properly.

In the first vehicle of the present invention of the aspect including the radiator and the roof cover, it may be allowed that a plurality of radiators are arranged in the vehicle fore/aft direction, the upper outside air introducing opening of the roof cover introduces outside air to a radiator placed on the front side among the plurality of radiators, and the roof cover has, in a side portion thereof, a side outside air introducing opening that opens so as to introduce outside air passing through a lateral side with running of the vehicle to a radiator placed on the rear side among the plurality of radiators. This allows the plurality of radiators to be placed in a compact manner and increases cooling efficiency of each radiator. In this case, it may be allowed that two radiators are arranged on the front side in the vehicle width direction and two radiators are arranged on the rear side in the vehicle width direction.

The present invention is also directed to a second vehicle that runs using power from a power source. The second vehicle includes: at least one gas fuel tank that stores gas fuel to be supplied to the power source, and is placed on a vehicle body roof; a radiator that is used for a cooling system of the power source, and placed on the rear in the vehicle fore/aft direction of the gas fuel tank on the vehicle body roof; and a roof cover that covers the vehicle body roof, and has an upper outside air introducing opening that opens so as to introduce to the radiator outside air passing through an upper side with running of the vehicle.

In the second vehicle of the present invention, the gas fuel tank is placed on the vehicle body roof, the radiator for a power source is placed on the rear of the gas fuel. tank, and the roof cover that covers the vehicle body roof has the upper outside air introducing opening that introduces to the radiator the outside air (running air) passing through the upper side with running of the vehicle. Thus, the radiator can be cooled using outside air passing through the upper side of the gas fuel tank. This can increase cooling efficiency of the radiator for a power source while ensuring a space for placement of the gas fuel tank. Also, the upper outside air introducing opening is provided on the rear of the gas fuel tank, and thus gas fuel leaking from the gas fuel tank can be diluted using the outside air introduced into the upper outside air introducing opening. The upper outside air introducing opening that introduces the outside air passing through the upper side to the radiator, which is because if a side outside air introducing opening is provided that introduces outside air passing through a lateral side into a radiator, the outside air needs to be introduced from as far forward as possible (the side closer to the gas fuel tank) for sufficiently introducing the outside air passing through the lateral side, which reduces spaces near opposite ends in a vehicle width direction of a gas fuel tank, while the outside air passing through the upper side is introduced to allow sufficient outside air to be introduced and ensure a maintenance space for the gas fuel tank. In this case, the gas fuel tank may be horizontally placed on the vehicle body roof so that a longitudinal direction thereof is in a vehicle width direction, may be horizontally placed on the vehicle body roof so that the longitudinal direction thereof is in the vehicle fore/aft direction, or may be vertically placed on the vehicle body roof so that the longitudinal direction thereof is in the vehicle width direction or the vehicle fore/aft direction. The gas fuel tank may have a substantially cylindrical shape.

In the second vehicle of the present invention, the roof cover may have a downward inclined surface descending from the portion above the gas fuel tank placed at the rearmost portion in the vehicle fore/aft direction to a lower end of the upper outside air introducing opening. This allows the outside air to be guided into the upper outside air introducing opening effectively using the shape of the substantially cylindrical gas fuel tank. In this case, the roof cover may have wall portions on opposite sides of the downward inclined surface in the vehicle width direction. This allows the outside air to be guided into the upper outside air introducing opening more properly.

In the second vehicle of the present invention, it may be allowed that a plurality of radiators are arranged in the vehicle fore/aft direction, the upper outside air introducing opening of the roof cover introduces outside air to a radiator placed on the front side among the plurality of radiators, and the roof cover has, in a side portion thereof, a side outside air introducing opening that opens so as to introduce outside air passing through a lateral side with running of the vehicle to a radiator placed on the rear side among the plurality of radiators. This allows the plurality of radiators to be placed in a compact manner and increases cooling efficiency of each radiator. In this case, it may be allowed that two radiators are arranged on the front side in the vehicle width direction and two radiators are arranged on the rear side in the vehicle width direction.

### BRIEF DESCRIPTION OF THE DRAWINGS

FIG. 1 is a schematic block diagram of a configuration of a fuel cell-equipped bus 20 according to an embodiment of the present invention.

FIG. 2 illustrates a state in which fuel cells 40a and 40b and a hydrogen tank 30 are mounted in a rear portion and on a roof 22, respectively, of the fuel cell-equipped bus 20.

FIG. 3 illustrates a region from a middle portion to a rear portion on the roof 22 of the fuel cell-equipped bus 20.

FIG. 4 illustrates placement of the hydrogen tank 30 or the like on the roof 22 of the fuel cell-equipped bus 20.

FIG. 5 illustrates arrangement of a plurality of radiators 42.

FIG. 6 illustrates an outside air introducing opening to radiators 42 in Comparative Example.

FIG. 7 illustrates an outside air introducing opening to radiators 42 in Comparative Example.

### BEST MODE FOR CARRYING OUT THE INVENTION

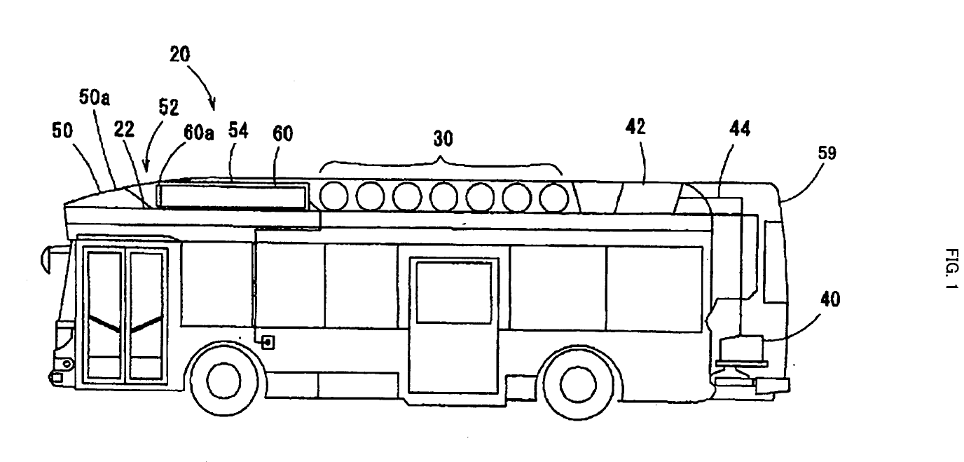

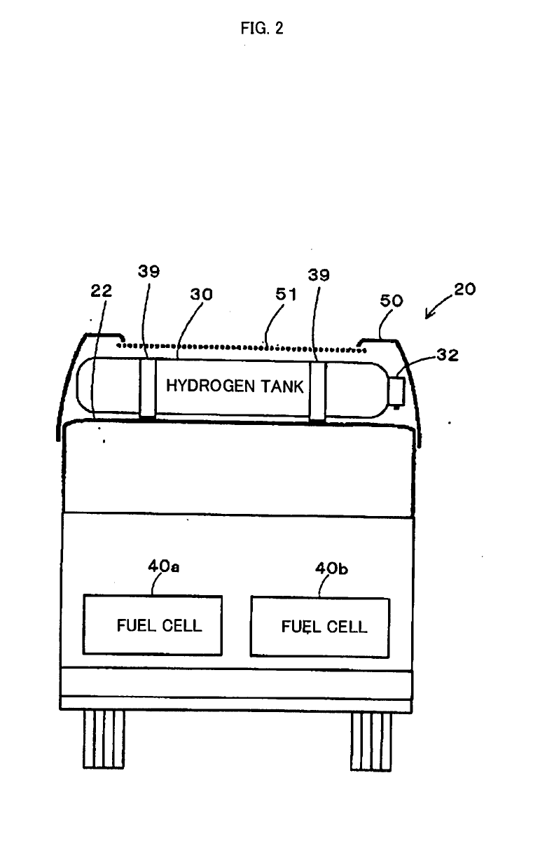

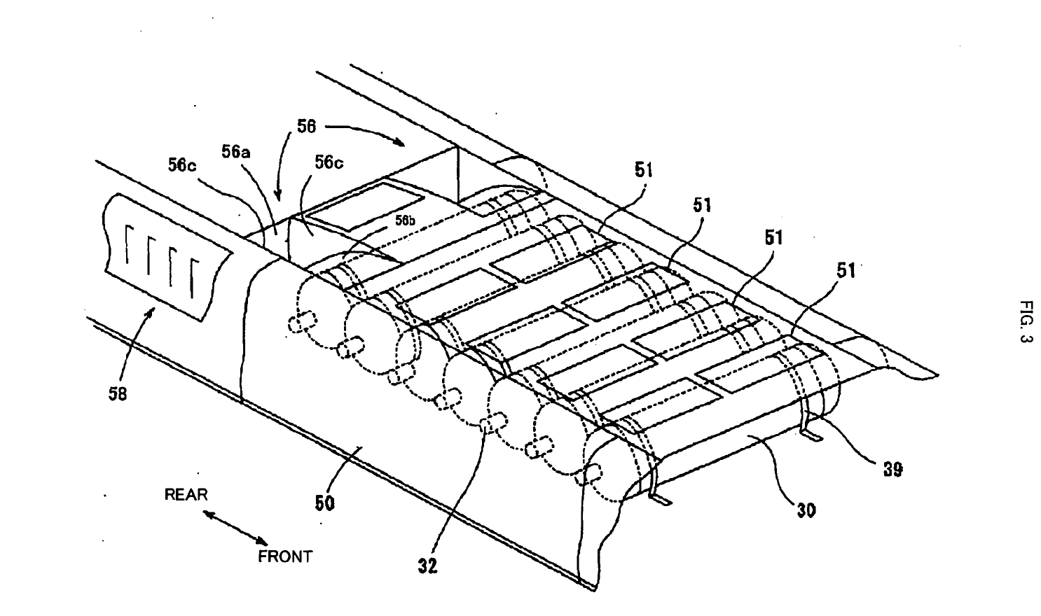

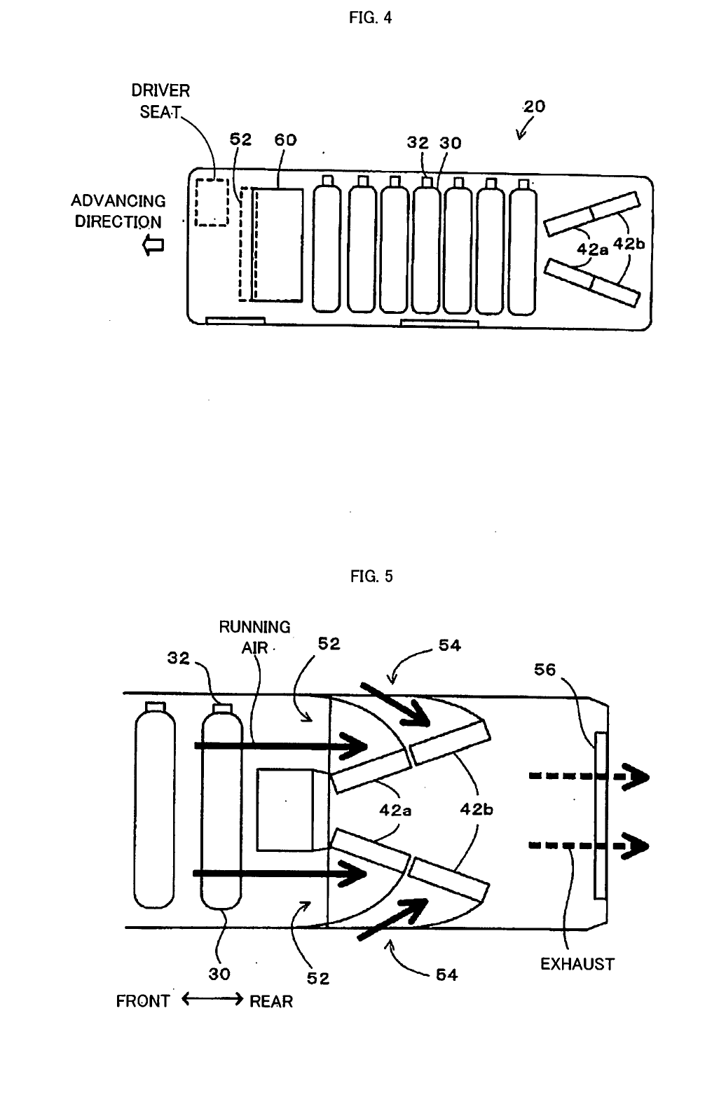

Now, the best mode for carrying out the invention will be described with reference to an embodiment. FIG. 1 is a schematic block diagram of a configuration of a fuel cell-equipped bus 20 according to an embodiment of the present invention, FIG. 2 illustrates a state in which fuel cells 40a and 40b and a hydrogen tank 30 are mounted in a rear portion and on a roof 22, respectively, of the fuel cell-equipped bus 20, FIG. 3 illustrates a region from a middle portion to a rear portion on the roof 22 of the fuel cell-equipped bus 20, and FIG. 4 illustrates placement of the hydrogen tank 30 or the like on the roof 22 of the fuel cell-equipped bus 20. As shown, the fuel cell-equipped bus 20 of the embodiment is. configured as a large bus that runs using the fuel cells 40a and 40b as a power source, and includes the fuel cells 40a and 40b in the rearmost portion thereof, and seven substantially cylindrical hydrogen tanks 30 that store hydrogen as fuel to be supplied to the fuel cells 40a and 40b substantially at a middle portion in a fore/aft direction on the roof 22. On the roof 22 of the fuel cell-equipped bus 20, besides the seven hydrogen tanks 30, an air conditioning unit 60 that conditions air in an occupant compartment is mounted on the front of the hydrogen tank 30, and a plurality of radiators 42 that cool the fuel cells 40a and 40b are mounted on the rear thereof, and these components are covered with a roof cover 50 having a plurality of ventilating openings 51 in a ceiling portion.

As shown in FIG. 2, a valve unit 32 is mounted to one end in a longitudinal direction of the hydrogen tank 30. In the valve unit 32, a pressure regulating valve that regulates pressure of hydrogen to be supplied to the fuel cells 40a and 40b and a fusible plug valve as a safety valve are incorporated, the fusible plug valve being fused at high temperature (for example, 110° C. or higher) to discharge hydrogen in the tank to the outside. The hydrogen tank 30 is horizontally placed on the roof 22 and mounted by belts 39 so that the valve unit 32 is placed on a right side of the fuel cell-equipped bus 20 and the longitudinal direction of the hydrogen tank 30 is in a vehicle width direction.

As shown in FIG. 1, the roof cover 50 includes, in the front portion thereof, an upward inclined surface 50a that rises from the frontmost portion to a portion above the hydrogen tank 30 through a portion above the air conditioning unit 60, and also includes an outside air guiding portion 52 (see FIG. 4) that is provided in the middle of the upward inclined surface 50a and above the front portion of an air conditioning unit 60, and guides outside air to an outside air introducing opening 60a of the air conditioning unit 60, and a partition wall portion 54 that is provided in the periphery of the air conditioning unit 60 on the side of the hydrogen tank 30 and separates the hydrogen tank 30 from the air conditioning unit 60. The upward inclined surface 50a reduces aerodynamic resistance of the fuel cell-equipped bus 20. The partition wall portion 54 prevents hydrogen leaking from the hydrogen tank 30 from flowing into the outside air introducing opening 60a of the air conditioning unit 60 through the inside of the roof cover 50.

The roof cover 50 includes, besides the ventilating holes 51, upper outside air introducing portions 56 that are provided at right and left corners on the rear of the hydrogen tank 30 and introduce running air above a ceiling portion to a radiator 42, and side outside air introducing portions 58 that are provided on right and left side surfaces slightly on the rear of the upper outside air introducing portions 56 and introduce running air on lateral sides to the radiator 42, or the like. Each upper outside air introducing portion 56 is constituted by an outside air introducing opening 56a that opens forward, a downward inclined surface 56b that descends from the portion above the hydrogen tank 30 in the rearmost position along an outer peripheral surface of the hydrogen tank 30 to a lower end of the outside air introducing opening 56a, and wall portions 56c provided on right and left sides of the downward inclined surface 56b, and running air guided by the downward inclined surface 56b and the wall portions 56c is introduced into the outside air introducing opening 56a.

The air conditioning unit 60 feeds outside air guided into the outside air introducing opening 60a by the outside air guiding portion 52 of the roof cover 50 or inside air introduced from the occupant compartment as cold air or hot air by heat exchange to condition air in the occupant compartment. The radiator 42 is connected to the fuel cells 40a and 40b through a cooling tube 44 in which cooling water as a cooling medium is circulated, and cools cooling water circulated in the cooling tube 44 by heat exchange with running air introduced by the upper outside air introducing portions 56 and the side outside air introducing portions 58 of the roof cover 50.

The radiator 42 is connected to the fuel cells 40a and 40b through a cooling tube 44 in which cooling water as a cooling medium is circulated, and cools cooling water circulated in the cooling tube 44 by heat exchange with running air introduced by the upper outside air introducing portions 56 and the side outside air introducing portions 58 of the roof cover 50. FIG. 5 illustrates arrangement of a plurality of radiators 42. As shown, the radiators 42 are constituted by four radiators 42a and 42b that are arranged in series at a predetermined angle (for example, any of angles of 15° to 60°) with respect to the center line in the vehicle fore/aft direction and to form mirror images with respect to the centerline. The two front radiators 42a are cooled by running air introduced by the upper outside air introducing portions 56, and the two rear radiators 42b are cooled by running air introduced by the side outside air introducing portions 58. The running air introduced by the upper outside air introducing portions 56 and the side outside air introducing portions 58 is exhausted from an exhaust port 59.

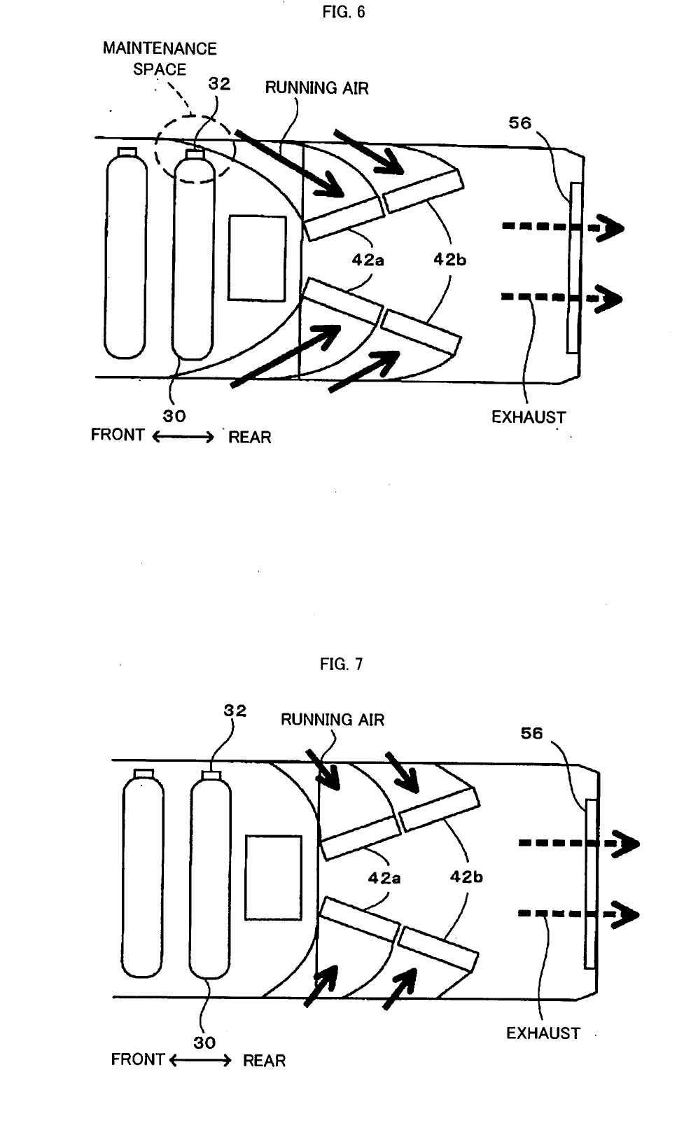

If the upper outside air introducing portion 56 that introduces running air to the front radiator 42a is configured to introduce running air on the lateral side similarly to the side outside air introducing portion 58, an introducing portion of the running air needs to be provided from as far forward as possible for sufficiently introducing the running air, which reduces a space near the valve unit 32 of the hydrogen tank 30 and affects a maintenance operation of the valve unit 32 (see FIG. 6). If the space near the valve unit 32 is to be ensured, the introducing portion of the running air cannot be provided on the front, which may cause insufficient running air to be introduced and reduce cooling efficiency of the radiator 42a (see FIG. 7). On the other hand, according to the upper outside air introducing portion 56 in the embodiment, sufficient running air can be introduced and a space near the valve unit 32 of the hydrogen tank 30 can be ensured.

According to the fuel cell-equipped bus 20 of the embodiment described above, the hydrogen tank 30 is placed on the roof 22 and the air conditioning unit 60 is placed on the front of the hydrogen tank 30. Thus, hydrogen leaking from the hydrogen tank 30 flows rearward by running air, and as compared with the case where the air conditioning unit 60 is placed on the rear of the hydrogen tank 30, hydrogen leaking from the hydrogen tank 30 can be more properly prevented from entering the occupant compartment through the outside air introducing opening 60a of the air conditioning unit 60. Also, the hydrogen tank 30 is placed substantially at the middle portion in the fore/aft direction on the roof 22, thereby ensuring a good weight balance and increasing vehicle mobility such as pivotability. Further, the radiator 42 is placed on the rear of the hydrogen tank 30. Thus, hydrogen leaking from the hydrogen tank 30 is introduced to the radiator 42 by the upper outside air introducing portion 56 and the side outside air introducing portion 58, and can be more properly prevented from entering the occupant compartment.

According to the fuel cell-equipped bus 20 of the embodiment, the roof cover 50 has the upward inclined surface 50a in the front portion thereof, thereby reducing aerodynamic resistance. Further, the roof cover 50 has the partition wall portion 54 that separates the hydrogen tank 30 from the air conditioning unit 60. This can more reliably prevent hydrogen leaking from the hydrogen tank 30 from entering the occupant compartment.

Further, according to the fuel cell-equipped bus 20 of the embodiment, the radiator 42 is placed on the rear of the hydrogen tank 30 on the roof 22, and the roof cover 50 has the upper outside air introducing portion 56 that introduces the running air on the upper side to the radiator 42. Thus, the radiator 42 can be cooled using the running air on the upper side. This can increase cooling efficiency of the radiator 42 while ensuring a space for placement of the hydrogen tank 30. Also, hydrogen leaking from the hydrogen tank 30 can be diluted using outside air introduced into the upper outside air introducing portion 56.

In the fuel cell-equipped bus 20 of the embodiment, the hydrogen tank 30 is placed substantially at the middle portion in the fore/aft direction on the roof 22, but may be placed on the front or rear portion.

In the fuel cell-equipped bus 20 of the embodiment, the radiator 42 is placed on the rear of the hydrogen tank 30. This arrangement is, however, not restrictive in any sense, and the radiators 42 may be located at any suitable place, instead of on the roof 22.

In the fuel cell-equipped bus 20 of the embodiment, the upper outside air introducing portion 56 is constituted by the outside air introducing opening 56a, the downward inclined surface 56b, and the wall portion 56c. However, it is sufficient that the upper outside air introducing portion 56 can introduce the running air on the upper side to the radiator 42, and the downward inclined surface 56b and the wall portion 56c may be omitted when not required.

In the fuel cell-equipped bus 20 of the embodiment, the radiators 42 are constituted by the four radiators 42a and 42b that are arranged in series at a predetermined angle (for example, any of angles of 15° to 60°) with respect to the centerline in the vehicle fore/aft direction and to form mirror images with respect to the centerline. However, the radiators 42 may be arranged in any manner as long as they are arranged so that running air introduced by the upper outside air introducing portion 56 is introduced to the radiator 42 placed on the front and running air introduced by the side outside air introducing portion 58 is introduced to the radiator 42 placed on the rear. The number of the radiators 42 is not restricted to 4 but may be only one or any other suitable number.

In the fuel cell-equipped bus 20 of the embodiment, the seven substantially cylindrical hydrogen tanks 30 are horizontally placed on the roof 22 and mounted by the belts 39 so that the longitudinal direction of the cylindrical hydrogen tanks 30 is in the vehicle width direction. However, the hydrogen tank 30 may have any shape, not limited to the substantially cylindrical shape, and the hydrogen tank 30 may be placed on the roof 22 in any direction, and for example, may be placed so that the longitudinal direction thereof is in the vehicle fore/aft direction. The hydrogen tank 30 may be vertically placed on the roof 22 rather than horizontally placed.

In the fuel cell-equipped bus 20 of the embodiment, the roof cover 50 has the upward inclined surface 50a in the front portion thereof. This upward inclined surface 50a may be omitted when not required. The partition wall portion 54 that separates the hydrogen tank 30 from the air conditioning unit 60 is provided, but this partition wall portion 54 maybe omitted when not required. It is not essential to cover the air conditioning unit 60 and the hydrogen tank 30 with the roof cover 50.

In the fuel cell-equipped bus 20 of the embodiment, the plurality of ventilating openings 51 are provided in the ceiling portion of the roof cover 50, but all the ventilating openings 51 may be placed on the rear side from the middle portion in the vehicle fore/aft direction. Thus, the outside air introducing opening 60a of the air conditioning unit 60 can be separated farther apart from the ventilating opening 51, thereby preventing hydrogen discharged outside from the roof cover 50 through the ventilating opening 51 from entering the occupant compartment through the outside air introducing opening 60a of the air conditioning unit 60. The ventilating opening 51 may be omitted when not required.

In the fuel cell-equipped bus 20 of the embodiment, the gas fuel is hydrogen gas, but of course not limited to this, and the gas fuel maybe other gas fuel such as natural gas. Also, the fuel cells 40a and 40b are mounted as the power source, but not limited to this, an engine that uses gas fuel such as hydrogen or natural gas may be mounted as a power source.

The embodiment and its modified examples discussed above are to be considered in all aspects as illustrative and not restrictive. There may be many other modifications, changes, and alterations without departing from the scope or spirit of the main characteristics of the present invention.

### INDUSTRIAL APPLICABILITY

The present invention is applicable in the vehicle production industry.

1. A vehicle that runs using power from a power source, said vehicle comprising:
a gas fuel tank that stores gas fuel to be supplied to said power source, and is placed on a vehicle body roof;
an air conditioning unit that is placed on the front in a vehicle fore/aft direction of said gas fuel tank on the vehicle body roof, has an outside air introducing opening that introduces outside air, and conditions air in an occupant compartment using the outside air introduced from said outside air introducing opening.

2. A vehicle according to claim 1, wherein said gas fuel tank is placed substantially at a middle portion in the vehicle fore/aft direction on the vehicle body roof.

3. A vehicle according to claim 1, wherein said gas fuel tank has a substantially cylindrical shape, and is horizontally placed on the vehicle body roof so that a longitudinal direction thereof is in a vehicle width direction.

4. A vehicle according to claim 1, further comprising a roof cover that covers at least said gas fuel tank and said air conditioning unit, and has an outside air guiding opening that guides outside air to the outside air introducing opening of said air conditioning unit.

5. A vehicle according to claim 4, wherein said air conditioning unit is formed to be lower than said gas fuel tank, and said roof cover is formed so that a portion above said air conditioning unit is lower than a portion above said gas fuel tank.

6. A vehicle according to claim 4, wherein said roof cover has a partition portion that separates the outside air introducing opening of said air conditioning unit from said gas fuel tank.

7. A vehicle according to claim 4, wherein said roof cover has a ventilating hole in an upper portion from a middle portion to a rear portion in the vehicle fore/aft direction.

8. A vehicle according to claim 1, further comprising a radiator that is placed on the rear in the vehicle fore/aft direction of said gas fuel tank on the vehicle body roof, and used for a cooling system of said power source.

9. A vehicle according to claim 8, further comprising a roof cover that covers the vehicle body roof, and has an upper outside air introducing opening that opens so as to introduce to said radiator outside air passing through an upper side with running of the vehicle.

10. A vehicle according to claim 9, wherein said roof cover has a downward inclined surface descending from the portion above the gas fuel tank placed at the rearmost portion in the vehicle fore/aft direction to a lower end of said upper outside air introducing opening.

11. A vehicle according to claim 10, wherein said roof cover has wall portions on opposite sides of said downward inclined surface in the vehicle width direction.

12. A vehicle according to claim 9, wherein a plurality of radiators are arranged in the vehicle fore/aft direction,
the upper outside air introducing opening of said roof cover introduces outside air to a radiator placed on the front side among said plurality of radiators, and
said roof cover has, in a side portion thereof, a side outside air introducing opening that opens so as to introduce outside air passing through a lateral side with running of the vehicle to a radiator placed on the rear side among said plurality of radiators.

13. A vehicle according to claim 9, wherein said roof cover covers at least said gas fuel tank and said air conditioning unit, and has an outside air guiding opening that guides outside air to the outside air introducing opening of said air conditioning unit.

14. A vehicle that runs using power from a power source, said vehicle comprising:
at least one gas fuel tank that stores gas fuel to be supplied to said power source, and is placed on a vehicle body roof;
a radiator that is used for a cooling system of said power source, and placed on the rear in the vehicle fore/aft direction of said gas fuel tank on the vehicle body roof; and
a roof cover that covers the vehicle body roof, and has an upper outside air introducing opening that opens so as to introduce to said radiator outside air passing through an upper side with running of the vehicle.

15. A vehicle according to claim 14, wherein said gas fuel tank has a substantially cylindrical shape, and is horizontally placed on the vehicle body roof so that a longitudinal direction thereof is in a vehicle width direction.

16. A vehicle according to claim 14, wherein said roof cover has a downward inclined surface descending from the portion above the gas fuel tank placed at the rearmost portion in the vehicle fore/aft direction to a lower end of said upper outside air introducing opening.

17. A vehicle according to claim 16, wherein said roof cover has wall portions on opposite sides of said downward inclined surface in the vehicle width direction.

18. A vehicle according to claim 14, wherein a plurality of radiators are arranged in the vehicle fore/aft direction,
the upper outside air introducing opening of said roof cover introduces outside air to a radiator placed on the front side among said plurality of radiators, and
said roof cover has, in a side portion thereof, a side outside air introducing opening that opens so as to introduce outside air passing through a lateral side with running of the vehicle to a radiator placed on the rear side among said plurality of radiators.
